(19) United States
(12) Patent Application Publication
(10) Pub. No.: US 2011/0193357 A1
(43) Pub. Date: Aug. 11, 2011

(54) BUMPER ARRANGEMENT FOR A MOTOR VEHICLE

(75) Inventor: Stanislaw KLIMEK, Frankfurt/Main (DE)

(73) Assignee: GM GLOBAL TECHNOLOGY OPERATIONS LLC, Detroit, MI (US)

(21) Appl. No.: 13/021,287

(22) Filed: Feb. 4, 2011

(30) Foreign Application Priority Data
Feb. 5, 2010 (DE) 102010006978.7

(51) Int. Cl. B60R 19/34

(52) U.S. Cl. 293/133

(57) ABSTRACT

A bumper arrangement is provided for a motor vehicle with a bumper member structure extending essentially in the transverse direction of the vehicle, which is operatively connected by means of at least one energy absorber in a load path-conveying manner with an end section of a frame side rail of the vehicle body lying in the front in the traveling direction of the vehicle, and with a carrier of the vehicle chassis lying underneath it.

### CROSS-REFERENCE TO RELATED APPLICATION

This application claims priority to German Patent Application No. 102010006978.7, filed Feb. 5, 2010, which is incorporated herein by reference in its entirety.

### TECHNICAL FIELD

The technical field relates to a bumper arrangement for a motor vehicle with a bumper member structure extending essentially in the transverse direction of the vehicle along the front of the vehicle.

### BACKGROUND

Bumper arrangements for motor vehicles typically have a bumper member structure with at least one bumper member extending along the front of the vehicle, essentially in the transverse direction of the vehicle. Such bumper members are usually secured to the bearing structure of the motor vehicle by means of individual energy absorbers, such as crash boxes. The energy absorbers are here designed as deformation bodies.

In known bumper arrangements, the area of the end sections of the bumper member structure lying outside in the transverse direction of the vehicle are each secured to the end sections of the frame side rail of the vehicle body lying in the front in the traveling direction by means of an energy absorber. During a frontal vehicular collision that takes place in the low-speed range, the defined deformation behavior allows the energy absorbers to largely absorb the impact energy, thereby making it possible to at least minimize or even completely avoid any damage to the frame side rails and other body components.

Known from DE 10 2005 059 447 A1 is a bumper system with a bumper cross member, which is held on a stiff frame of the motor vehicle. Also provided is a deformable outer bumper skin, and a compressible structure arranged between an upper area of the outer skin and the cross member. A carrier section that supports the lower area of the outer skin is here anchored together with a crash box that carries the cross member to flange plates of the frame.

However, in known bumper arrangements, the forces to be dissipated during a collision can only be optimally absorbed by the energy absorbers if the point of collision lies in the area of the bumper cross member. In vehicular collisions where the vehicles, and hence their bumper structures, are arranged at varying heights over the traversable surface, the respective bumper arrangements of the vehicles involved hit each other offset relative to each other. The load path distribution and energy diversion within the vehicle body along with the impact absorption are then most often only sub-optimal.

Collision scenarios like these are increasingly being encountered in vehicular collisions where a motor vehicle with a comparatively high clearance, such as an SUV (sport utility vehicle), collides with a subcompact.

In this regard, at least one object is to provide an improved bumper arrangement that exhibits an improved impact energy-absorbing behavior even in vehicular collisions with bumper arrangements that only overlap regionally in the vertical direction of the vehicle (z). In addition, at least one object of the invention is to improve the structural and torsional stiffness of the vehicle front section without any significant increase, preferably even given a decrease in vehicle weight. In addition, other objects, desirable features and characteristics will become apparent from the subsequent summary and detailed description, and the appended claims, taken in conjunction with the accompanying drawings and this background.

### SUMMARY

A bumper arrangement is provided in particular for the front section of a motor vehicle body. It here has a bumper member structure that extends essentially in the transverse direction of the vehicle, and is operatively connected with an end section of a frame side rail of the vehicle body lying in the front in the traveling direction of the vehicle, typically by means of one or more crash boxes. A bumper member structure is also operatively connected in a load path-conveying manner with a carrier of the vehicle chassis lying under the frame side rail by means of the energy absorber.

As a result, an improved attachment and improved mechanical coupling of an energy absorber are provided with two separate structural components of the motor vehicle lying behind the latter in a traveling direction, specifically with a frame side rail of the vehicle body and a carrier of the vehicle chassis. In this way, forces caused by a collision can also be absorbed comparatively well even if introduced into the bumper member structure under the frame side rail of the vehicle body.

The additional support provided for the energy absorber or the crash box on the chassis carrier can increase the absorbing capacity of the entire bumper arrangement in a vertical direction. It is here especially advantageous for the energy absorber to be built high enough to cover at least the front faces or surfaces of both the frame side rail of the body and the chassis carrier.

In addition to an improved collision and energy absorption behavior, attaching the energy absorber further yields an improved structural and torsional stiffness of the entire motor vehicle front section. The end sections of the frame side rails of the body and chassis carriers lying in the front in the traveling direction are also joined directly with each other by means of the energy absorber.

A first embodiment provides that the front faces of the frame side rails and chassis carriers designed as profile sections lying in the front in the traveling direction are each sealed by means of a separate anchor plate. The anchor plates are here separately and individually secured to the ends of the frame side rail and chassis carrier profiles lying in the traveling direction. The anchor plate also is used to alternately secure the energy absorber and respective carrier. In the event of a collision, it diverts the forces acting upon it on the face in the respective carrier.

Another embodiment further provides that the front faces of the frame side rails and chassis carriers designed as profile sections lying in the front in the traveling direction essentially come to lie flush over each other, and are sealed by means of a shared anchor plate extending between the frame side rail and chassis carrier. Instead of two separate anchor plates respectively secured to the frame side rail and chassis carrier, it is here provided that only a single anchor plate be provided on the front surfaces of the frame side rail and chassis carrier. In this case, the anchor plate itself stiffens the front section of the motor vehicle. With respect to the one-piece and continuous anchor plate, it is also conceivable to secure the energy absorber to the anchor plate with attachment means to be provided outside the profile cross section of the frame side rail and/or chassis carrier.

In another embodiment, the anchor is integrally bonded with the frame side rail and/or the chassis carrier. This can be done by welding or cold soldering, but also by riveting or screwing the anchor plate with the frame side rail and/or the chassis carrier.

In another preferred embodiment, the anchor plate has at least one through hole to accommodate attachment means for the energy absorber. The receptacle is here provided within the profile section of the frame side rail and/or chassis carrier. In the case of a one-piece anchor plate joined with the frame side rail and chassis carrier, it can also lie outside the respective profile cross section. The anchor plate can also be provided with welding nuts, so that the energy absorber can be assembled to the anchor plate secured on the body or chassis side merely by screwing in studs provided for this purpose.

Another embodiment further provides that the energy absorber has two legs, which are jointly supported by the anchor plate on the frame side rail and/or chassis carrier, and widen in the form of a V relative to the bumper structure situated upstream in the traveling direction viewed in the transverse direction of the vehicle. The widened ends of the energy absorber pointing toward the front in the traveling direction are here fixed to the bumper cross member, preferably welded thereto.

The V-shaped progression of the two crash box legs is such that the leg lying on the outside in the transverse direction of the vehicle projects outward, while the leg lying on the inside projects inward. This structure of the energy absorber provides an improved energy absorption behavior, in particular in cases where a vehicular collision takes place not from the front, but from the side, and corresponding transverse forces must be intercepted and absorbed. In another embodiment, the leg of the energy absorber lying on the inside extends convexly inward, and the leg of the energy absorber lying on the outside extends convexly outward.

In addition, the widened or V-shaped curved progression of the legs makes it possible to shorten the distance between the front end of the frame side rail or chassis carrier and the bumper member structure. As a result, the overall vehicle overhang can be shortened. The two-legged, widening crash box also increases the flexural strength of the bumper member structure, since both respective legs join the latter with the crash box. These two legs provide two attachment points per crash box for the bumper member structure.

The V-shaped or bent progression of the legs also enables an earlier load transfer to the energy absorber itself given a collision. In addition, the deformation range of the bumper member structure is tangibly reduced as the result of the at least four force absorption points, which coincide with the front ends of the legs. As a result, the engine compartment aggregates are better protected against damage as well.

The legs themselves are preferably designed as a closed hollow profile. They further have an edgewise geometry, meaning they extend more in the vertical direction of the vehicle than in the transverse direction of the vehicle (y). For example, the vertical extension of the legs can measure approximately 1.5 to 3 times the transverse extension of the hollow profile leg.

In a further embodiment, a honeycomb structure is arranged between the legs of the energy absorber. The legs themselves can be designed with a U or closed profile, which is filled with honeycomb or hexagonal structures. In addition, it is further conceivable for such hexagonal reinforcing or stiffening structures to be arranged not just in the profiles of the legs, but also between the widening legs. The resultant increase in structural stiffness of the energy absorbers makes it possible to reduce its dimensions in an advantageous manner, in particular in the longitudinal direction of the vehicle.

The forwardly widened ends of the legs can further accommodate or incorporate at least one connecting web, which can be used to secure the bumper member structure to the vehicle, for example via a threaded joint. It can also be provided that the widened end sections of the legs of the energy absorber lying in the front be joined integrally with the bumper member structure, for example via welding or hard soldering.

Another embodiment further provides that the bumper member structure has at least two cross members, one upper and one lower one. The upper cross member here extends essentially in the transverse direction of the vehicle above the energy absorber, while the lower cross member extends parallel hereto, but below the energy absorber. The cross members are preferably integrally fixed or attached with the widened end sections of the energy absorbers lying in the front, for example via welding or hard soldering.

Such a two-component bumper member structure with an upper and lower cross member offers a weight advantage by comparison to a continuous structure. In addition, the overall height of the energy absorber makes it possible to realize a comparably large distance between the upper and lower cross member, so that the effective range of action for the bumper arrangement can be increased, in particular toward the bottom. In addition, because the energy absorber is in operatively connected directly with a chassis carrier, in particular the forces and energies introduced in the area of the lower cross member given a collision can be better absorbed and diverted into the vehicle structure. Another advantage to the two-part design of the bumper member structure with an upper and lower cross member is that cool air can flow between the mentioned cross members toward the engine compartment situated behind them.

Another embodiment further provides that the upper and lower cross members are directly joined with each other not just via their respective attachment to the energy absorbers lying behind them, but also by means of a connecting element, for example, in the form of a reinforcement plate. This reinforcement plate is preferably secured roughly centrally between the energy absorbers on the side on the upper and lower cross members.

The reinforcement plate creates spacing between the upper and lower cross members, and divides the gap between the latter into a left and right cool air passage. The reinforcement plate serves to additionally reinforce the structure of the upper and lower cross beam, and can further cause collision forces and energies introduced centrally into the bumper member structure to be laterally diverted to the energy absorbers. Finally, the reinforcement plate can act as an air baffle for cool air to be supplied.

### BRIEF DESCRIPTION OF THE DRAWINGS

The present invention will hereinafter be described in conjunction with the following drawing figures, wherein like numerals denote like elements, and

FIG. 1 is a perspective front view of the vehicle frame and chassis;

FIG. 2 is a cut view of the attachment of the bumper arrangement to the frame side rail and chassis carrier;

FIG. 3 is a sectional view of the bumper arrangement viewed from above;

FIG. 4 is an overall view of another embodiment of the bumper arrangement, also viewed from above; and

FIG. 5 is a diagrammatic front view of the bumper arrangement with a central reinforcement plate.

### DETAILED DESCRIPTION

The following detailed description is merely exemplary in nature and is not intended to limit application and uses. Furthermore, there is no intention to be bound by any theory presented in the preceding background or summary or the following detailed description.

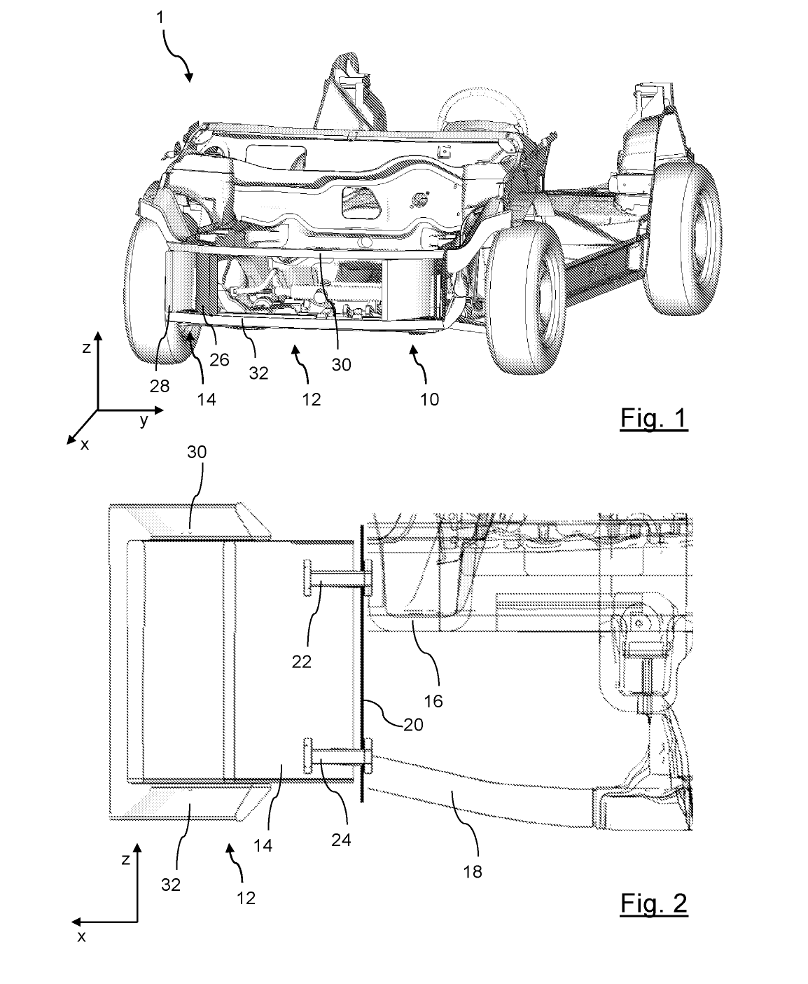

The motor vehicle 1 shown on FIG. 1 depicts only the vehicle chassis with a perspective, front view of the vehicle frame. The front section of the motor vehicle here has a bumper arrangement 10, which is secured by two laterally situated energy absorbers 14 both to the frame side rails 16 and to a chassis carrier located under it, as evident from the cross section according to FIG. 2.

The bumper arrangement 10 has a bumper cross member 12 with an upper cross member 30 and a lower cross member 32. Situated on the left and right between the two cross members 30, 32 are respective energy absorbers 14, which in the present exemplary embodiment each have two legs 26, 28 that widen away from each other and toward the front, in the traveling direction of the motor vehicle.

The widening ends of the legs 26, 28 of the energy absorbers 14 lying to the front are rigidly joined with both the upper cross member 30 and the lower cross member 32 of the bumper member structure 12. The connection is preferably fabricated integrally, for example by welding or hard soldering. As an alternative, a threaded joint can also be provided.

The overall height of the energy absorbers 14 corresponds at least to the clearance between the upper and lower cross members 30, 32. In light of this comparatively high design, the energy absorbers 14 can have a twofold attachment to the vehicle, specifically at the front end section of the body frame side rail 16, as well as at a front end section of a chassis carrier 18 lying underneath it. Therefore, the energy absorbers 14 abut the vehicle in two areas spaced apart from each other in the vertical direction of the vehicle (z). This makes it possible to achieve an overall improvement in the vertical range of action of the energy absorbers 14, and hence the entire bumper arrangement 10. As a result, introduced collision-induced forces and energies are not diverted just into the frame side rail 16, but distributed to both the frame side rail 16 and the chassis carrier 18 lying underneath it.

The respective mechanical load placed on the frame side rail 16 and cross member 30 can hence be advantageously reduced. For attachment purposes and also to divert acting collision-induced forces, at least one anchor plate 20 is provided between the energy absorber 14 and the front surfaces of the carrier components 16, 18 designed like a profile lying in the front. In the exemplary embodiment according to FIG. 2, the free end sections of the frame side rail 16 and chassis carrier 18 lying in the front in the traveling direction essentially come to lie flush over each other, so that both carrier profiles 16, 18 can be sealed by means of a single anchor plate 20.

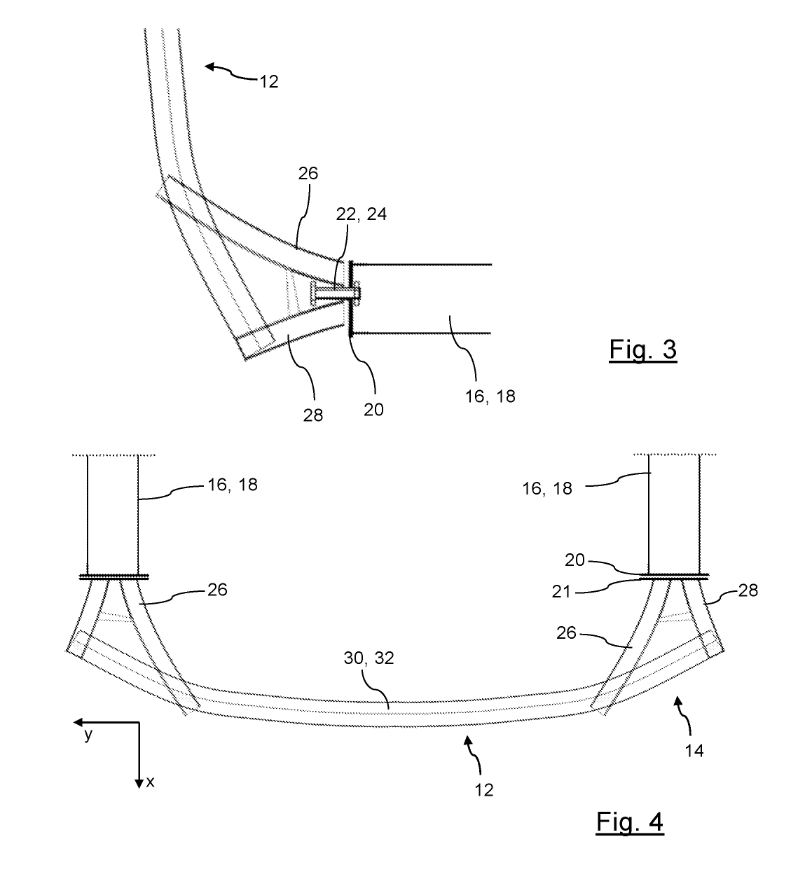

Hence, the anchor plate 20 joins the front end sections of the frame side rail 16 and chassis carrier 18. In addition, it provides a possible attachment means for the energy absorber 14. As indicated on FIG. 2 and FIG. 3, the anchor plate 20 has through holes for accommodating studs 22, 24 in the area of the profile cross sections of the frame side rail 16 and chassis carrier 18. The anchor plate 20 can here further be pre-configured with welding nuts for a simple assembly of the energy absorber 14.

The legs 26, 28 of the energy absorber 14 directed outward or inward and toward the front viewed in the traveling direction (x) are explicitly depicted on FIGS. 3 and 4. The legs 26, 28 along with the gap formed by the legs 26, 28 and bumper member structure 12 can be provided with structure-reinforcing means, such as a hexagonal or hexagonally honeycomb reinforcing structure made of plastic.

While FIG. 3 shows a threaded joint connecting the crash box with the allocated frame side rails 16, 18, the configuration according to FIG. 4 provides for another anchor plate 21 on the crash box. The latter faces the anchor plate 20 on the carrier side. For example, the legs 26, 28 of the energy absorber 14 are here welded onto the anchor plate 21. All that need then be done to assemble the energy absorber 14 is to join the two anchor plates 21, 20 to each other using suitable connecting and jointing techniques, for example welded or threaded joints.

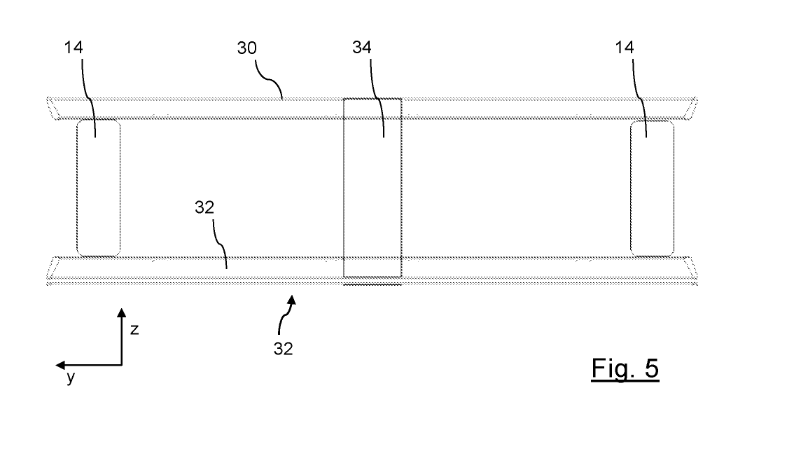

In the top view according to FIG. 5, the laterally arranged energy absorbers 14 are only shown diagrammatically. According to the embodiments, it is of course also conceivable to provide conventional energy absorbers having a cubic or square basic geometry instead of a V-shaped structure. FIG. 5 shows the division of the bumper member structure 12 into the upper cross member 30 and lower cross member 32. These are additionally joined together by means of a reinforcement plate 34 largely situated centrally between the energy absorbers 14.

The reinforcement plate 34 can here assume the function of conducting cooling air, but primarily diverts the forces acting centrally in the bumper member structure 12 up and down toward the respective cross members 30, 32, which on their part introduce the forces acting on them into the energy absorbers 14 for the controlled deformation of the latter. Individual venting channels for the supply of cooling air can be formed between the lateral energy absorbers 14 and the essentially centrally arranged reinforcement plate 34 between the upper and lower cross members 30, 32.

The reinforcement plate 34 is comparatively massive, and has a minimum thickness of about 100 mm. The cross members 30, 32 consist of a high-tensile and unbreakable material, for example a metal or aluminum alloy. As a whole, the described bumper arrangement can yield a higher compatibility in vehicular collisions with vehicles varying in weight and height dimensions, while simultaneously providing the greatest possible freedom in the frontal design of the engine hood, fenders, radiator grill and headlamp structures.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A bumper arrangement for a motor vehicle, comprising:
a bumper member structure extending essentially in a transverse direction of the motor vehicle;
an energy absorber operatively connecting the bumper member structure in a load path-conveying manner with an end section of a frame side rail of a body of the motor vehicle lying in a front in a traveling direction of the motor vehicle; and
a carrier of a chassis connected to the energy absorber and lying underneath the energy absorber.

2. The bumper arrangement according to claim 1, wherein front faces of the frame side rail and the carrier have profile sections lying in the front in the traveling direction and sealed with an anchor plate

3. The bumper arrangement according to claim 2, wherein the front faces of the frame side rail and the carrier have profile sections lying in the front in the traveling direction and essentially lay flush over each other, and sealed with a shared anchor plate extending between the frame side rail and the carrier.

4. The bumper arrangement according to claim 2, wherein the anchor plate is integrally joined with the frame side rail.

5. The bumper arrangement according to claim 2, wherein the anchor plate is integrally joined with the carrier.

6. The bumper arrangement according to claim 2, wherein the anchor plate comprises at least one through hole for accommodating an attachment for the energy absorber.

7. The bumper arrangement according to claim 2, wherein the energy absorber comprises two legs jointly supported by the anchor plate on the frame side rail, and widen in a V relative to the bumper member structure \situated upstream in the traveling direction viewed in the transverse direction of the motor vehicle.

8. The bumper arrangement according to claim 2, wherein the energy absorber comprises two legs jointly supported by the anchor plate on the carrier, and widen in a V relative to the bumper member structure \situated upstream in the traveling direction viewed in the transverse direction of the motor vehicle.

9. The bumper arrangement according to claim 7, wherein a connecting structure with a honeycomb design is arranged between the two legs.

10. The bumper arrangement according to claim 7, wherein the two legs of the energy absorber lying on an inside and an outside each extend convexly inward and outward.

11. The bumper arrangement according to claim 7, wherein the bumper member structure comprises an upper cross member situated above the energy absorber and a lower cross member situated below the energy absorber.

12. The bumper arrangement according to claim 11, wherein free end sections of the upper cross member and the lower cross member are each integrally joined with the end section of the two legs of the energy absorber facing toward the front in the traveling direction.

13. The bumper arrangement according to claim 11, wherein the upper cross member and the lower cross member are joined with a reinforcement plate roughly centrally between the energy absorber situated on edges.

14. A motor vehicle, comprising:
a motor vehicle body;
a frame side rail of the motor vehicle body;
a bumper member structure extending essentially in a transverse direction of the motor vehicle;
an energy absorber operatively connecting the bumper member structure in a load path-conveying manner with an end section of the frame side rail lying in a front in a traveling direction of the motor vehicle;
a chassis; and
a carrier of the chassis connected to the energy absorber and lying underneath the energy absorber.

15. The motor vehicle according to claim 14, wherein front faces of the frame side rail and the carrier have profile sections lying in the front in the traveling direction and sealed with an anchor plate

16. The motor vehicle according to claim 15, wherein the front faces of the frame side rail and the carrier have profile sections lying in the front in the traveling direction and essentially lay flush over each other, and sealed with a shared anchor plate extending between the frame side rail and the carrier.

17. The motor vehicle according to claim 15, wherein the anchor plate is integrally joined with the frame side rail.

18. The motor vehicle according to claim 15, wherein the anchor plate is integrally joined with the carrier.

19. The motor vehicle according to claim 15, wherein the anchor plate comprises at least one through hole for accommodating an attachment for the energy absorber.

20. The motor vehicle according to claim 15, wherein the energy absorber comprises two legs jointly supported by the anchor plate on the frame side rail, and widen in a V relative to the bumper member structure situated upstream in the traveling direction viewed in the transverse direction of the motor vehicle.
